(19) United States
(12) Patent Application Publication
(10) Pub. No.: US 2026/0129660 A1
(43) Pub. Date: May 7, 2026

(54) INDICATION OF UNUSED TRANSMISSION OCCASIONS FOR SIDELINK COMMUNICATION

(71) Applicant: QUALCOMM Incorporated, San Diego, CA (US)

(72) Inventors: Shijun WU, San Diego, CA (US); Kapil GULATI, Belle Mead, NJ (US); Huilin XU, Temecula, CA (US)

(21) Appl. No.: 18/940,737

(22) Filed: Nov. 7, 2024

(51) Int. Cl. H04W 72/40; H04L 5/00; H04W 92/18

(52) U.S. Cl. CPC H04W 72/40; H04L 5/0092; H04W 92/18

(57) ABSTRACT

Certain aspects of the present disclosure provide techniques for wireless communications. An example method includes obtaining a configured grant (CG) configuration indicating a plurality of sidelink transmission occasions in a CG period; and sending, associated with a multi-block sidelink data transmission on the plurality of sidelink transmission occasions, an indication of an unused status for one or more sidelink transmission occasions of the plurality of sidelink transmission occasions.

### INTRODUCTION

### Field of the Disclosure

Aspects of the present disclosure relate to wireless communications, and more particularly, to techniques for sidelink communications.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes obtaining a configured grant (CG) configuration indicating a plurality of sidelink transmission occasions in a CG period; and sending, associated with a multi-block sidelink data transmission on the plurality of sidelink transmission occasions, an indication of an unused status for one or more sidelink transmission occasions of the plurality of sidelink transmission occasions.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts an example of sidelink communications.

FIG. 6 depicts an example of sidelink communications and access link communications.

FIG. 7 depicts an example scheme for configuring configured grant (CG) configurations.

FIG. 8A depicts an example of CG configurations having overlapping transmission occasions (TOs).

FIG. 8B depicts an example of CG configurations having TOs offset in time from each other.

FIG. 9 depicts a process flow for communications in a network between a network entity and a UE and between the UE and a sidelink communications receiving (RX) UE to communicate unused TOs for sidelink communications.

FIG. 10 depicts an example configuration of unused TOs for sidelink communications for a CG period.

FIG. 11 depicts another example configuration of unused TOs for sidelink communications for a CG period.

FIG. 12 depicts yet another example configuration of unused TOs for sidelink communications for a CG period.

FIG. 13 depicts a further example configuration of unused TOs for sidelink communications for a CG period.

FIG. 14 depicts a method for wireless communications.

FIG. 15 depicts aspects of an example communications device.

### DETAILED DESCRIPTION

Aspects of the present disclosure provide apparatuses, methods, processing systems, and computer-readable mediums for handling of unused transmission occasions (TOs) in sidelink communications. In some aspects, TOs in sidelink communications may be referred to as sidelink TOs.

Certain wireless communications systems, such as 5G New Radio (NR) systems and/or future wireless communications technologies, allow for peer-to-peer communications. In peer-to-peer communications, a user equipment (UE) communicates directly with other UEs without an access network or network entity, such as a base station (BS), relaying such communications between the UEs. Such peer-to-peer (P2P) communications (also referred to as device-to-device (D2D) communications) may include sidelink communications. An example of sidelink communications includes vehicle-to-everything (V2X) communications where a vehicle may communicate with another vehicle, a UE, a roadside unit (RSU), etc. Communications between a vehicle and another vehicle are referred to as vehicle-to-vehicle (V2V) communications. Though certain aspects may be discussed with respect to certain types of D2D communications in a D2D communications system, it should be noted that the aspects may apply to other suitable types of P2P communications systems. To address rapid increase of wireless data traffic demand especially for sidelink communications, certain wireless communications systems allow for wireless traffic in unlicensed or shared spectrum bands as a way to add wireless channel capacity. Some unlicensed or shared spectrum bands may use a distributed channel access mechanism. A distributed channel access mechanism may provide for UEs or users to obtain channel access by transmitting a reservation of a resource, such as based on channel sensing. The channel sensing may use, for example, a listen-before-talk (LBT) scheme.

In some wireless communications systems, a UE may be provided a periodic resource allocation to communicate with a network entity, such as a BS, or other UEs. The periodic resource allocation may reduce signaling overhead and latency encountered for dynamic resource scheduling. The periodic resource allocation may be referred to as semi-persistent scheduling (SPS) for downlink communications and a configured grant (CG) for uplink communications. In some cases, a periodic resource allocation may be configured for certain traffic with periodic transmissions, such as voice traffic or video traffic. In certain cases, a periodic resource allocation may be configured for traffic with certain latency and/or reliability specifications, such as ultra-reliable low latency communications (URLLC). URLLC may include, for example, extended reality (XR) traffic. XR traffic may include virtual reality (VR) traffic, augmented reality (AR) traffic, and/or mixed reality (MR) traffic. Other examples of URLLC include industrial automation communications such as discrete automation, V2X communications such as intelligent transport, smart electric grid communications, etc.

For sidelink communications, two resource allocation modes are supported. The two resource allocation modes can be configured separately or simultaneously. A first resource allocation mode, referred to as Mode 1, supports scheduling by NR Uu interface. “NR Uu interface” refers to a radio interface between a UE and an access network. In Mode 1, a network entity schedules sidelink resources to be used by the UE for sidelink communications. A second resource allocation mode, referred to as Mode 2, supports autonomous UE operation. In Mode 2, the UE senses and selects resources on a sidelink based on the sidelink resources configured by the network entity.

For safety-application-oriented V2X communications, a UE transmitting on a sidelink may perform autonomous resource allocation. For example, such safety-application-oriented V2X communications may be allocated to be transmitted as sidelink communications in Intelligent Transportation Systems (ITS) spectrum. The ITS spectrum is dedicated to V2X communications. In some examples, there may be no access network coverage in the ITS spectrum. Accordingly, the sidelink communications may be performed in an autonomous and distributed manner, such as by allocating resource in Mode 2.

To accommodate increasing resource demands for sidelink communications, a UE may transmit on licensed spectrum, where the UE may rely on Mode 1 resource allocation by a network entity for sidelink communications. Mode 1 resource allocation supports CG for reduced scheduling latency. A UE may send a message with UE assistance information to a BS. The message may indicate characteristics about expected sidelink traffic, such as data periodicity and maximum size, etc. The BS then configures a CG to the UE that satisfies transmission requirements for the expected sidelink traffic. A resource allocation of the CG may provide certain allocated time and frequency resources within a given time period for sidelink communications. The given time period is referred to herein as a CG period. The allocated time and frequency resources are referred to as TOs. Each TO may be allocated for transmission or retransmission of a transport block (TB). A TB may include a unit of data that is accepted by physical layer to be encoded jointly and corresponds to a portion of a data packet generated by application layer.

In some deployments, the allocated time and frequency resources include a maximum number of TOs per CG period. In such deployments, while the UE can decide how to use the allocated time and frequency resources, the UE can transmit only one new TB with the maximum number of TOs. Alternatively, in some cases, the resource allocation may be a multi-TB/multi-TO sidelink resource allocation. For the multi-TB/multi-TO sidelink resource allocation, the allocated time and frequency resources may be allocated for transmitting multiple TBs using multiple TOs. In some aspects, transmitting multiple TBs on a sidelink may be referred to as a multi-block sidelink data transmission. For example, a first TB may be transmitted on a first set of TOs of the multi-TB/multi-TO sidelink resource allocation and a second TB may be transmitted on a second set of TOs of the multi-TB/multi-TO sidelink resource allocation.

One example scenario for V2X communication is for a UE, such as mounted on a vehicle, to connect with other UEs (e.g., mounted on other vehicles, held by or on vulnerable road users, etc.) in the UE's vicinity for safety-related applications. In this example, the V2X communication is transmitted by a transmitting UE (TX UE) as a broadcast or groupcast communication. A broadcast or groupcast communication may be a communication that does not receive acknowledgement (ACK) or negative acknowledgement (NACK) from the receiving UEs (RX UEs). For example, a broadcast communication may be transmitted to all UEs within range, whereas a groupcast transmission may be transmitted to a defined group of UEs. A TX UE may send an initial transmission of a TB, followed by one or more retransmissions of the TB to ensure that the TB is received and decoded successfully by the RX UEs. This results in use of all allocated TOs in a given CG period, without the possibility of re-allocating any TO for other uses. For example, one of the allocated TOs may be used for the initial transmission of the TB, and the remaining ones of the allocated TOs may be used for the retransmissions of the TB. Thus, reliability of safety-related traffic is improved.

With other types of sidelink communications, such as for XR traffic and/or traffic associated with a multi-TB/multi-TO sidelink resource allocation, a large amount of data may be communicated at a given compression rate, such as for XR traffic. For example, for a 1080p video frame with 10-bit color depth and 1% compression, a data packet with approximately 207,000 bits may be transmitted every 33 milliseconds (ms) assuming a 30 Hertz (Hz) frame rate. As video frame packet sizes are varying, the multi-TB/multi-TO sidelink resource allocation may result in degraded resource utilization/efficiency. For example, the multi-TB/multi-TO sidelink resource allocation may be performed with an assumption for a maximum video packet size. The assumption for the maximum video packet size may mean that the multi-TB/multi-TO sidelink resource allocation allocates a maximum number of TBs allowed per CG period corresponding to the maximum video packet size, with a number of TOs being allocated for an initial transmission and retransmissions of each TB. However, in some cases, a number of TBs to be transmitted for a given CG period may be less than the maximum number of TBs allowed per CG period, such as when a video packet to be transmitted for the given CG period is smaller than the maximum video packet size. When the number of TBs to be transmitted for the given CG period is less than the maximum number of TBs allowed for the given CG period, one or more TOs may end up unused after the given CG period. Thus, an improved resource utilization is desired for multi-TB/multi-TO sidelink communications. Moreover, similar improved resource utilization may be desired for other forms of sidelink communications when one or more TOs may end up unused after a CG period.

Certain aspects described herein provide signaling designs to support handling of unused TOs in sidelink communications. The signaling described herein may allow a UE to determine one or more TOs and/or TBs to be unused for a CG period and provide an indication of the unused TOs and/or TBs to a network entity and/or a RX UE for improved resource utilization. In some aspects, the indication of unused TOs may be referred to as an indication of unused status for the TOs. For example, an unused TO may be associated with an unused status. In certain aspects, the one or more TOs and/or TBs reported to the network entity and/or the RX UE to be unused by the UE may aid the network entity and/or the RX UE in re-allocating time and frequency resources associated with the one or more unused TOs and/or TBs for other UEs or communications, thus increasing throughput and spectral efficiency.

In certain aspects, a UE may determine a number of TBs to be transmitted for a CG period, which is less than a maximum number of TBs allowed for the CG period. For example, the UE may determine that not all TOs of the CG period will be used based on the number of TBs being less than the maximum number of TBs. Further, the UE may determine that not all TOs of the CG period will be used based on one or more TBs not being expected to use a maximum allowed number of retransmissions. In some cases, even if the UE may determine that each of the TBs to be transmitted for the CG period will use the maximum allowed number of retransmissions, the UE may determine that not all TOs of the CG period will be used based on at least one TB not being transmitted for the CG period. In this case, the TOs associated with such TB(s) not being transmitted will be unused for the CG period. In other cases, the UE may determine that not all of the TBs to be transmitted for the CG period will require the maximum allowed numbers of retransmissions or even same numbers of retransmissions, such that one or more TOs are unused for retransmissions of the TBs. In some aspects, the number of TBs may be referred to as a number of blocks.

In each of the cases described above, the UE may determine a number of unused TOs, such as corresponding to one or more TBs to be unused and/or one or more retransmissions to be unused. In some examples, the UE may identify TOs toward the end of the CG period corresponding to the determined number of unused TOs as the unused TOs, such that a latency associated with sending a data packet for the CG period may be minimized.

In some aspects, a number of unused TOs may be based on a TO-to-TB mapping. In some cases, a set of consecutive TOs may be mapped to a TB, followed by additional consecutive sets of consecutive TOs mapped to, respectively, additional TBs. In some cases, TOs mapped to multiple TBs may be interleaved in time. For these aspects, the UE may determine one or more TBs to be unused for a CG period. Then, the UE may identify the TOs to be unused based on the TO-to-TB mapping. When sets of consecutive TOs are mapped to respective TBs, the UE may use a reduced size of a buffer for transmitting a TB, when compared to when the TOs are interleaved in time, since the UE only needs to be concerned with a single TB at once. When TOs are interleaved in time, a latency associated with sending a data packet for the CG period may be reduced, when compared to when the TOs are organized as sets of consecutive TOs, particularly when a data packet may be successfully received and decoded by a RX UE without any retransmission.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

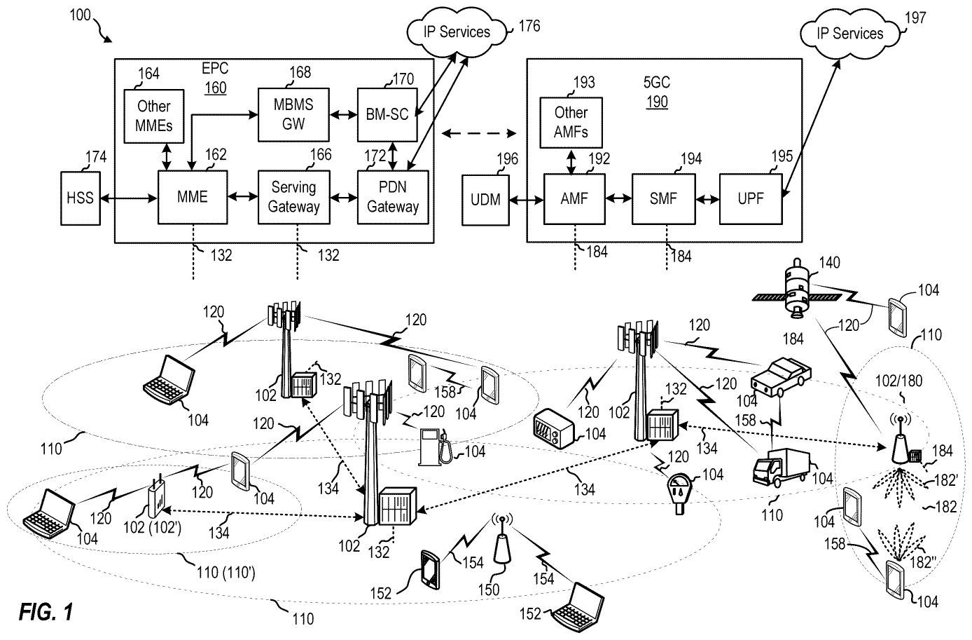

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

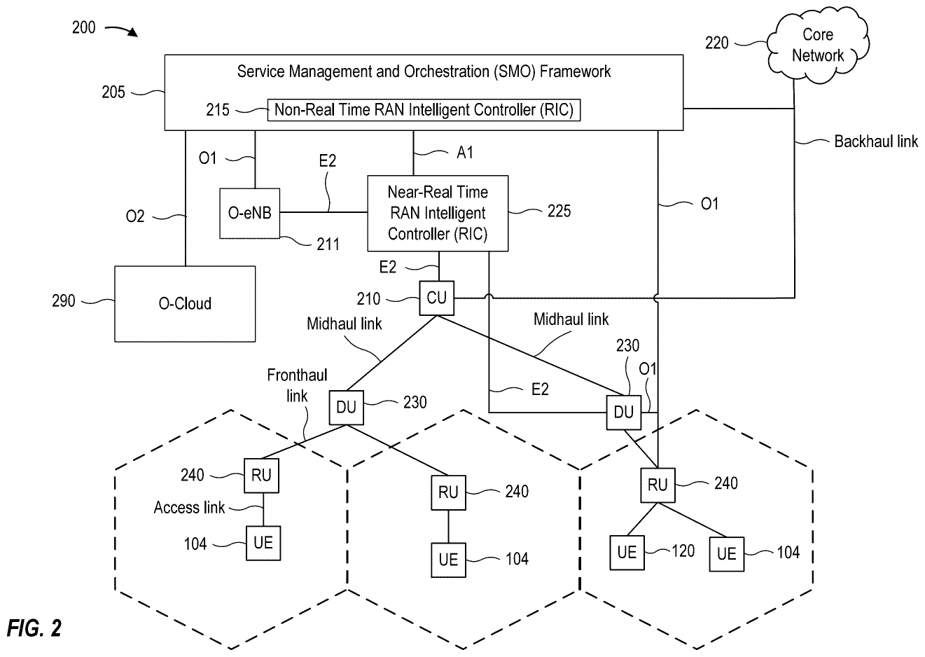

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2 -2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using D2D communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit - User Plane (CU-UP)), control plane functionality (e.g., Central Unit - Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate artificial intelligence/machine learning (AI/ML) models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

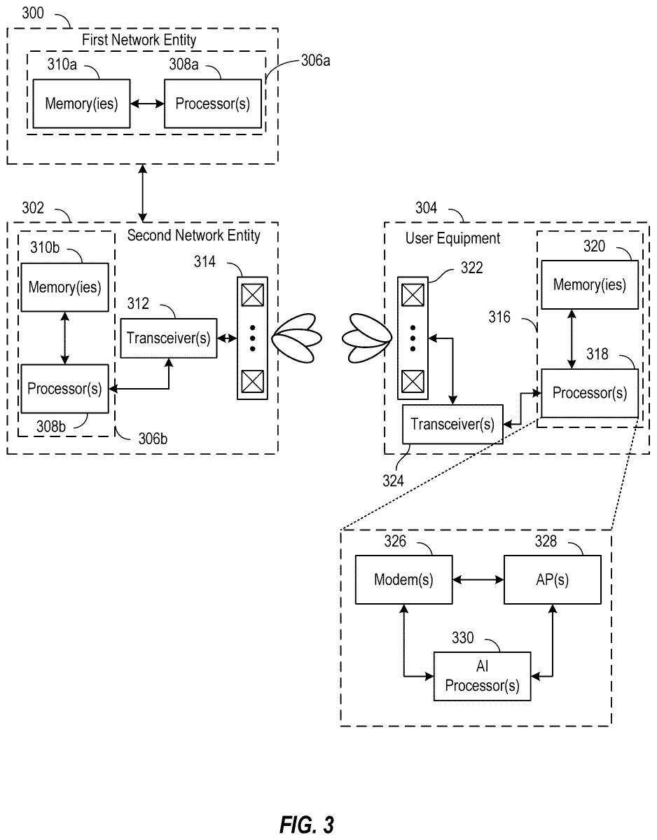

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

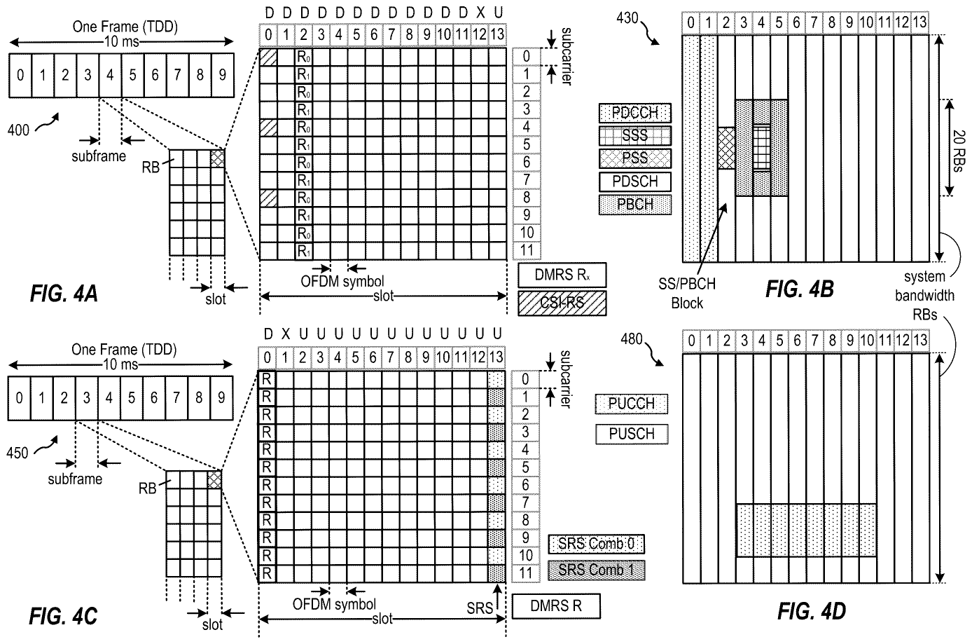

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2 slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Sidelink Communications

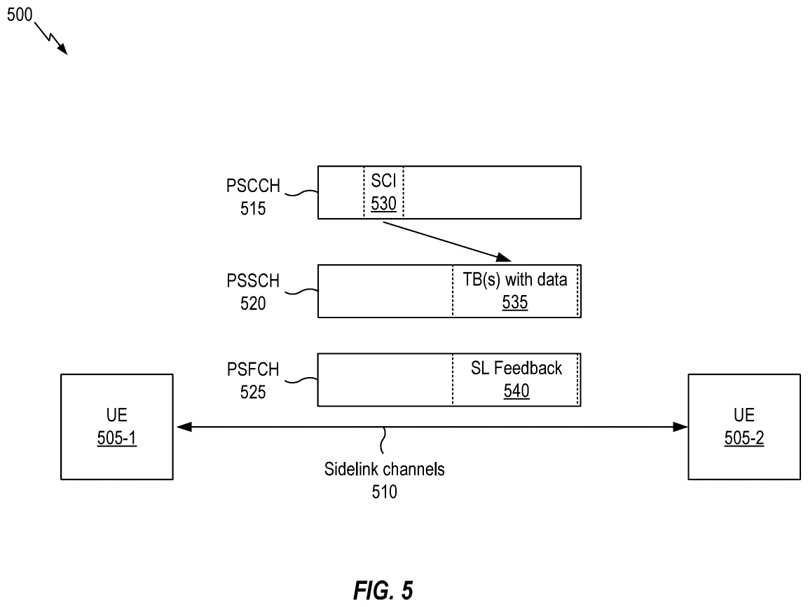

FIG. 5 depicts an example 500 of sidelink communications.

As shown in FIG. 5, a first UE 505-1 may communicate with a second UE 505-2 (and one or more other UEs 505) via one or more sidelink channels 510. The UEs 505-1 and 505-2 may communicate using the one or more sidelink channels 510 for P2P communications, D2D communications, V2X communications (e.g., which may include V2V communications, vehicle-to-infrastructure (V2I) communications, and/or vehicle-to-pedestrian (V2P) communications) and/or mesh networking. In some aspects, the UEs 505 (e.g., UE 505-1 and/or UE 505-2) may be an example of UE 104 depicted and described with respect to FIG. 1 or the UE 304 depicted and described with respect to FIG. 3. However, in other aspects, the UEs 505 may be another type of wireless communications device, such as those described herein. In some aspects, the one or more sidelink channels 510 may use a PC5 interface and/or may operate in a high frequency band (e.g., the 5.9 GHz band). Additionally, or alternatively, the UEs 505 may synchronize timing of transmission time intervals (TTIs) (e.g., frames, subframes, slots, or symbols) using global navigation satellite system (GNSS) timing.

As further shown in FIG. 5, the one or more sidelink channels 510 may include a physical sidelink control channel (PSCCH) 515, a physical sidelink shared channel (PSSCH) 520, and/or a physical sidelink feedback channel (PSFCH) 525. The PSCCH 515 may be used to communicate control information, similar to a physical downlink control channel (PDCCH) and/or a physical uplink control channel (PUCCH) used for cellular communications with a BS 102 via an access link or an access channel. The PSSCH 520 may be used to communicate data, similar to a physical downlink shared channel (PDSCH) and/or a physical uplink shared channel (PUSCH) used for cellular communications with a BS 102 via an access link or an access channel. For example, the PSCCH 515 may carry sidelink control information (SCI) 530, which may indicate various control information used for sidelink communications, such as one or more resources (e.g., time resources, frequency resources, and/or spatial resources) where a transport block (TB) 535 may be carried on the PSSCH 520. The TB 535 may include data. The PSFCH 525 may be used to communicate sidelink feedback 540, such as hybrid automatic repeat request (HARQ) feedback (e.g., acknowledgement or negative acknowledgement (ACK/NACK) information), transmit power control (TPC), and/or a scheduling request (SR).

In some aspects, the SCI 530 may include multiple communications in different stages, such as a first stage SCI (SCI-1) and a second stage SCI (SCI-2). The SCI-1 may be transmitted on the PSCCH 515. The SCI-2 may be transmitted on the PSSCH 520. The SCI-1 may include, for example, an indication of one or more resources (e.g., time resources, frequency resources, and/or spatial resources) on the PSSCH 520, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 520, such as a HARQ process ID, a new data indicator (NDI), a source identifier, a destination identifier, and/or a channel state information (CSI) report trigger.

In some aspects, the one or more sidelink channels 510 may use resource pools. For example, a scheduling assignment (e.g., included in SCI 530) may be transmitted in sub-channels using specific resource blocks (RBs) across time. In some aspects, data transmissions (e.g., on the PSSCH 520) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 505 may operate using a transmission mode where resource selection and/or scheduling is performed by the UE 505 (e.g., rather than a BS 102). In some aspects, the UE 505 may perform resource selection and/or scheduling by sensing channel availability for transmissions. For example, the UE 505 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 505 may perform resource selection and/or scheduling using SCI 530 received in the PSCCH 515, which may indicate occupied resources and/or channel parameters. Additionally, or alternatively, the UE 505 may perform resource selection and/or scheduling by determining a channel busy rate (CBR) associated with various sidelink channels, which may be used for rate control (e.g., by indicating a maximum number of resource blocks that the UE 505 can use for a particular set of subframes).

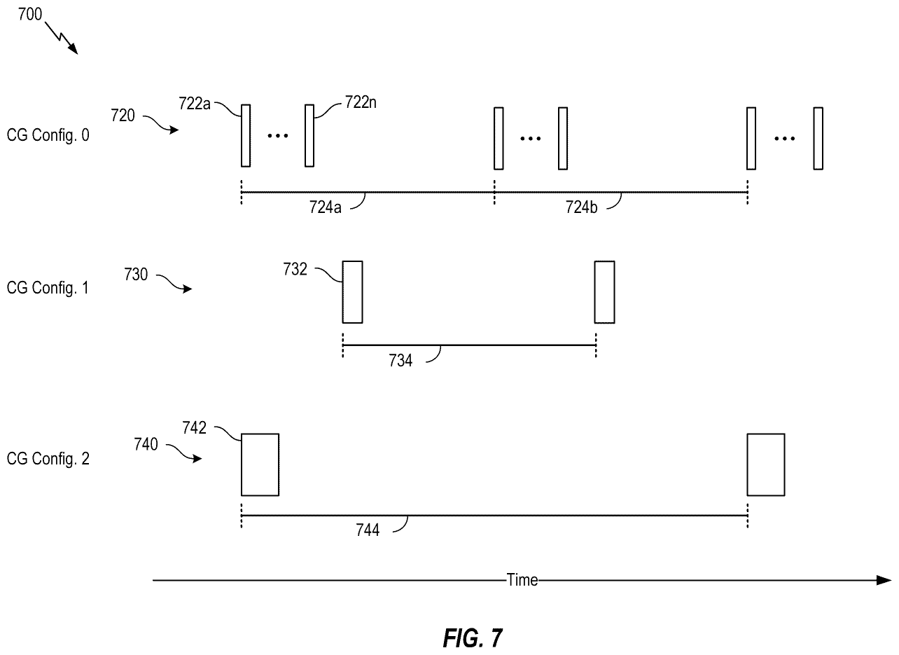

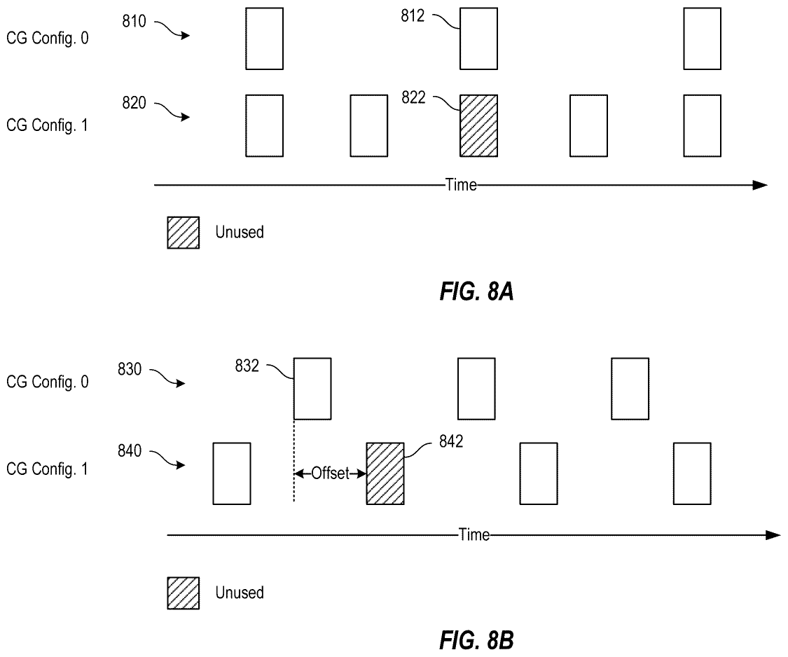

In the transmission mode where resource selection and/or scheduling is performed by a UE 505, the UE 505 may generate sidelink grants, and may transmit the grants in SCI 530. A sidelink grant may indicate, for example, one or more parameters (e.g., transmission parameters) to be used for an upcoming sidelink transmission, such as one or more resource blocks to be used for the upcoming sidelink transmission on the PSSCH 520 (e.g., for TBs 535), one or more subframes to be used for the upcoming sidelink transmission, and/or an MCS to be used for the upcoming sidelink transmission. In some aspects, a UE 505 may generate a sidelink grant that indicates one or more parameters for semi-persistent scheduling (SPS), such as a periodicity of a sidelink transmission. Additionally, or alternatively, the UE 505 may generate a sidelink grant for event-driven scheduling, such as for an on-demand sidelink message. In certain aspects, the sidelink grant described above may correspond to a CG described with respect to FIGS. 7, 8A, and 8B.

FIG. 5 is provided as an example. Other examples may differ from what is described with respect to FIG. 5.

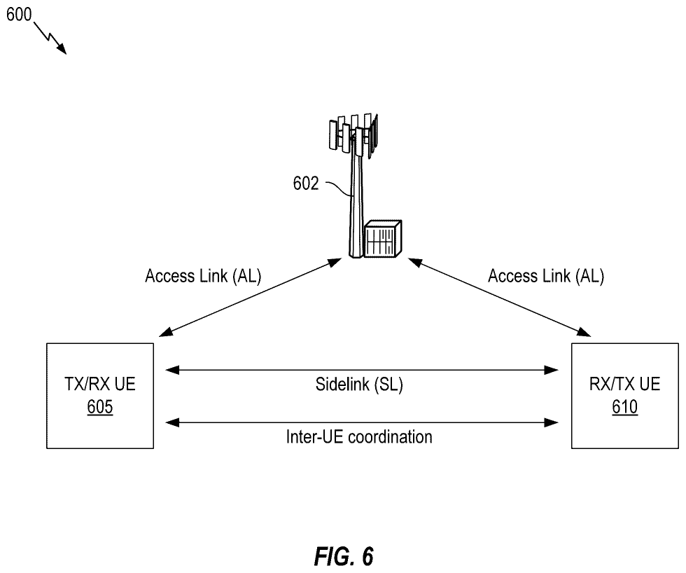

FIG. 6 depicts an example 600 of sidelink communications and access link communications. As shown in FIG. 6, a TX/RX UE 605 and an RX/TX UE 610 may communicate with one another via a sidelink, as described above in connection with FIG. 5. As further shown, in some sidelink modes, a BS 602 may communicate with the TX/RX UE 605 via a first access link. Additionally, or alternatively, in some sidelink modes, the BS 602 may communicate with the RX/TX UE 610 via a second access link. In some aspects, the TX/RX UE 605 and/or the RX/TX UE 610 may each be an example of UE 104 depicted and described with respect to FIG. 1 or the UE 304 depicted and described with respect to FIG. 3. Similarly, the BS 602 may be an example of the BS 102 depicted and described with respect to FIG. 1, the first network entity 300 or the second network entity 302 depicted and described with respect to FIG. 3, or a disaggregated base station depicted and described with respect to FIG. 2. However, in other aspects, the TX/RX UE 605 and/or the RX/TX UE 610 may be another type of wireless communications device and the BS 602 may be another type of network entity or network node, such as those described herein. Thus, a direct link between UEs 605, 610 (e.g., via a PC5 interface) may be referred to as a sidelink, and a direct link between a BS 602 and a UE 605, 610 (e.g., via a Uu interface) may be referred to as an access link. Sidelink communications may be transmitted via the sidelink, and access link communications may be transmitted via the access link. An access link communication may be either a downlink communication (from a BS 602 to a UE 605, 610) or an uplink communication (from a UE 605, 610 to a BS 602).

FIG. 6 is provided as an example. Other examples may differ from what is described with respect to FIG. 6.

### Example Configured Grant Configurations

FIG. 7 illustrates an example scheme 700 for configuring CG configurations, such as multiple CG configurations 720, 730, 740, for example, for a multi-modal service (such as XR). In this example, a UE (e.g., XR device(s)) is configured with one or more of a first CG configuration 720 (also labeled as CG configuration 0), a second CG configuration 730 (also labeled as CG configuration 1), or a third CG configuration 740 (also labeled as CG configuration 2). In certain cases, each of the CG configurations 720, 730, 740 may include periodic resource allocations configured for a specific traffic stream of the multi-modal service. As an example, the first CG configuration 720 may be configured to carry traffic of a first modality, such as video frame traffic; the second CG configuration 730 may be configured to carry traffic of a second modality, such as control information; and the third CG configuration 740 may be configured to carry traffic of a third modality, such as audio traffic (e.g., voice traffic) and/or data traffic.

The first CG configuration 720 includes one or more periodic resource allocations, for example, time-frequency resources as described herein with respect to FIGS. 4A-4D. For example, the first CG configuration 720 may define that multiple transmission occasions (TOs) 722a-n (arranged in a sequence over time) are allocated in a first period 724a of the first CG configuration 720, and so on for subsequent periods, for example, a second period 724b of the first CG configuration 720. A TO may represent or correspond to one or more communication resources (e.g., time resource(s) and frequency resource(s)) scheduled for a communication (e.g., a signal transmission or reception). The periodic resource allocations of the first CG configuration 720 are representative of the other CG configurations 730, 740. For example, the second CG configuration 730 may define that a TO 732 is allocated in a period 734 of the second CG configuration 730, and the third CG configuration 740 may define that a TO 742 is allocated in a period 744 of the third CG configuration 740.

In this example, the periodicity of the second CG configuration 730 is offset in time from the first CG configuration 720. The first CG configuration 720 and the second CG configuration 730 have the same duration of periodicity. The third CG configuration 740 has a periodicity duration that is longer than the first CG configuration 720 and the second CG configuration 730, for example, twice the duration.

Note that the CG configurations 720, 730, 740 are examples of configurations for a multi-modal service. Other CG configurations may be used in addition to or instead of those depicted in FIG. 7. For example, the CG configurations may have different periodicities, different periodicity offsets or alignments, different multi-transmission occasions per period, different time domain resource allocations, different frequency domain resource allocations, different MCSs, etc.

FIG. 8A illustrates an example of CG configurations 810, 820 having overlapping TOs. In this example, a UE may be configured with a first CG configuration 810 and a second CG configuration 820. The first CG configuration 810 has a first TO 812 that overlaps in time with a second TO 822 of the second CG configuration 820. In some cases, the second TO 822 may be unused by the UE for communicating data as depicted with the diagonal fill pattern.

FIG. 8B illustrates an example of CG configurations 830, 840 having transmission occasions offset in time from each other. In this example, a UE may be configured with a third CG configuration 830 and a fourth CG configuration 840. The third CG configuration 830 has a third TO 832 that is offset in time from a fourth TO 842. In some cases, the fourth TO 842 may be unused by the UE for communicating data as depicted with the diagonal fill pattern.

As discussed above, the UE may be configured to notify a network entity of whether a TO is unused (e.g., 822 and 842) to allow the network entity to reschedule the TO for other traffic. For example, the UE may multiplex an unused TO (UTO) UCI (UTO-UCI) in each CG PUSCH transmission for a CG PUSCH configuration to inform the network entity of any UTOs. Aspects described herein provide selection and indication of unused status for TOs (e.g., sidelink TOs), as described below.

In some aspects, the network entity described with respect to FIG. 8B may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE described with respect to FIGS. 7, 8A, and 8B may be an example of UE 104 depicted and described with respect to FIG. 1 or the UE 304 depicted and described with respect to FIG. 3. However, in other aspects, the UE may be another type of wireless communications device and the network entity may be another type of network entity or network node, such as those described herein.

### Example Signaling of Indication of Unused Transmission Occasions for Sidelink Communications

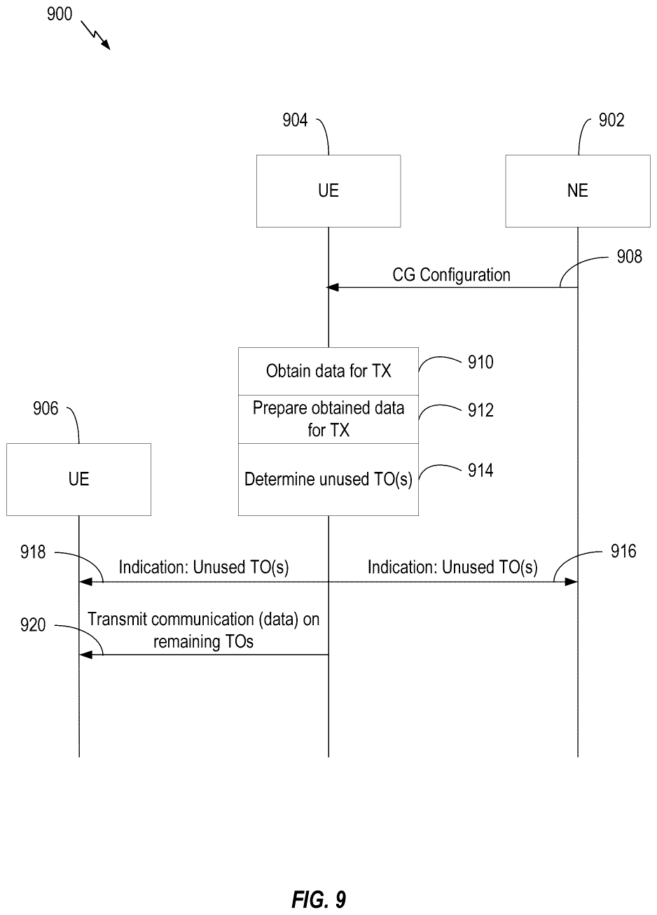

FIG. 9 depicts a process flow 900 for communications in a network between a network entity 902, a first UE 904, and a second UE 906. In some aspects, the network entity 902 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the first UE 904 and the second UE 906 may each be an example of UE 104 depicted and described with respect to FIG. 1 or the UE 304 depicted and described with respect to FIG. 3. However, in other aspects, the first UE 904 and/or the second UE 906 may be another type of wireless communications device and network entity 902 may be another type of network entity or network node, such as those described herein. Note that, while the first UE 904 and the second UE 906 are depicted and described as, respectively, a sidelink communications TX UE and a sidelink communications RX UE, the TX and RX UE roles may be reversed in certain aspects, such that the first UE 904 may be a sidelink communications RX UE and the second UE 906 may be a sidelink communications TX UE.

In process flow 900, an indication of one or more unused TOs is illustrated as being provided to a network entity 902 and to a second UE 906. In some aspects, the indication is provided to only one of the network entity 902 or the second UE 906.

At 908, the first UE 904 obtains, from the network entity 902, a CG configuration, such as described with respect to FIGS. 7, 8A, and 8B. In certain aspects, the CG configuration may include one or more periodic resource allocations, for example, of time-frequency resources as described herein with respect to FIGS. 4A-4D. For example, the CG configuration may include resource allocations (referred to herein as TOs) for sidelink communications between the first UE 904 and the second UE 906.

In certain aspects, the time-frequency resources may be allocated for a high capacity sidelink traffic, such as XR traffic. For example, the sidelink traffic may carry a video frame captured by one or more XR on-board cameras sent to a smartphone over a sidelink for, for example, computation offloading from the XR on-board cameras to the smartphone or data relay from the XR on-board cameras to the smartphone, and to network.

In certain aspects, to accommodate the high resource demands for sidelink communications such as for XR traffic, the first UE 904 may transmit on licensed spectrum, where the first UE 904 may rely on Mode 1 resource allocation by a network entity, such as network entity 902, for sidelink communications. Resource allocation by the network entity may aid the first UE 904 in avoiding reduced system performance due to interference.

In some aspects, the first UE 904 may send a message with UE assistance information to network entity 902. The message may indicate characteristics about expected sidelink traffic, such as data periodicity and maximum size, etc. The network entity 902 may then configure a CG to the first UE 904 that satisfies transmission requirements for the expected sidelink traffic. A resource allocation for the CG may provide certain allocated time and frequency resources within a CG period for sidelink communications, where the CG period may also be referred to as a CG PSSCH period. The allocated time and frequency resources are referred to herein as TOs, where each TO may be allocated for transmission or retransmission of a TB.

In certain aspects, the CG may be configured using one or more parameters, including a CG index corresponding to one of multiple CG configurations, time-frequency resource allocation such as allocation of slots described with respect to FIGS. 4A, 4B, 4C, and 4D and sub-channels described with respect to FIG. 5, and/or periodicity.

As described above, in some deployments, the allocated time and frequency resources include a maximum number of TOs per CG period. In such deployments, a UE, such as the first UE 904, can decide how to use the allocated time and frequency resources, but the UE can transmit only one new TB with the maximum number of TOs. For example, certain ones of the allocated time and frequency resources may be for retransmissions of a new TB of a current CG period and/or a new TB of a previous CG period. Alternatively, in some cases, the resource allocation may be a multi-TB/multi-TO sidelink resource allocation. For the multi-TB/multi-TO sidelink resource allocation, the allocated time and frequency resources may be allocated for transmitting multiple TBs using multiple TOs. For example, a first TB may be transmitted on a first set of TOs of the multi-TB/multi-TO sidelink resource allocation and a second TB may be transmitted on a second set of TOs of the multi-TB/multi-TO sidelink resource allocation. For example, an XR video frame can be segmented and sent over multiple TBs within a CG period. However, as video frame packet sizes often vary and thus one or more TOs of the multi-TB/multi-TO sidelink resource allocation may go unused, certain aspects of the present disclosure determine or identify used and unused TOs of the multi-TB/multi-TO resource allocation having initial transmission and retransmission resources for the varying video frame packet sizes. As described further herein, determining or identifying used and unused TOs enables improved resource utilization/efficiency by allowing the unused TOs to be cancelled or recycled.

At 910, the first UE 904 obtains data to be transmitted to the second UE 906 over a sidelink. For example, the data to be transmitted may include high capacity traffic data such as XR video data. As another example, the data may include any form of sidelink data transmission.

At 912, the first UE 904 prepares the obtained data to be transmitted to the second UE 906 as part of a multi-TB communication. For example, the first UE 904 may process and package the XR video data for a multi-TB data transmission. In some aspects, the XR video data may include, for example, an XR video frame to transmit to the second UE 906 using multiple TBs.

At 914, the first UE 904 determines one or more unused TOs of the CG configuration based on the data prepared at 912. In certain aspects, at the start of a CG period, the first UE 904 may identify a number of TBs to be transmitted in the CG period. For example, the number of TBs to be transmitted during the CG period may be based on a packet size of the data to be transmitted to the second UE 906, such as a packet size of the XR video frame to be transmitted in the CG period. In some aspects, the packet size indicates how many TBs will be used and thus how many TOs will be unused. For example, if a packet size satisfies a threshold associated with two TBs, the first UE 904 may determine that the corresponding packet will be transmitted in two TBs, and may identify a number of used TOs (and by extension, a number of unused TOs) sufficient to carry the two TBs.

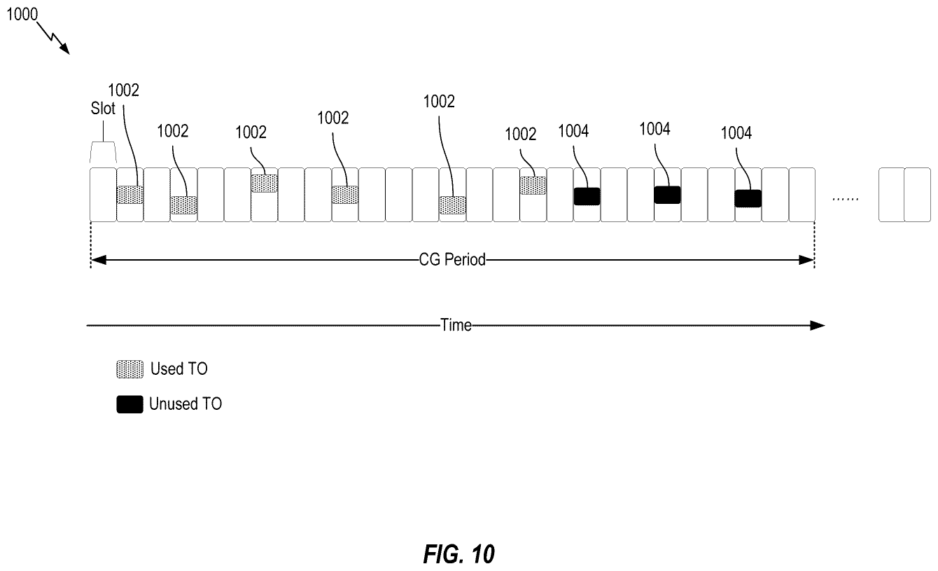

In some cases, the first UE 904 may determine the unused TOs based on the number of TBs to be transmitted in the CG period. In other cases, the first UE 904 may determine the unused TOs based on the number of TBs to be transmitted in the CG period as well as a number of retransmissions that may be needed for each of the TBs. In some aspects, the number of retransmissions that may be needed for the TBs may be referred to as a quantity of retransmissions of a set of blocks. Additional details regarding how the unused TOs are determined are described with respect to FIGS. 10-13.

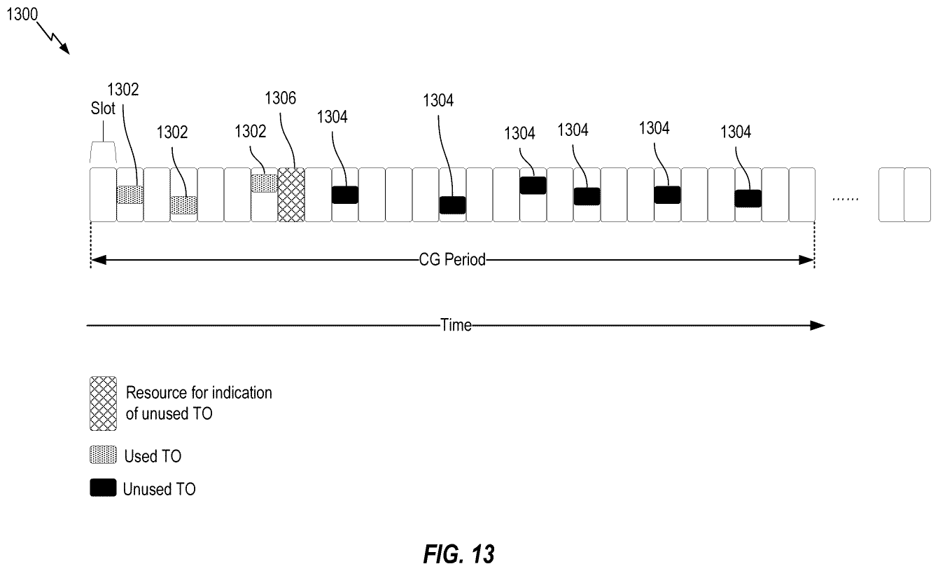

At 916, in some aspects, the first UE 904 sends, to the network entity 902 and using certain uplink resources, an indication of the unused TOs determined at 914. Signaling mechanisms and/or the certain uplink resources for reporting the unused TOs to the network entity 902 may be based on (1) the unused TOs being determined based on a number of TBs to be transmitted in a CG period, or (2) the unused TOs being determined based on a number of TBs to be transmitted in a CG period as well as on a number of retransmissions that may be needed for each of the TBs, as described herein with respect to FIGS. 10 and 13. Upon receiving the indication of the unused TOs, the network entity 902 may recycle the time-frequency resources corresponding to the unused TOs by, for example, allocating such time-frequency resources to other UEs via dynamic grant.

At 918, in some aspects, the first UE 904 sends, to the second UE 906, an indication of the unused TOs determined at 914. In certain aspects, the first UE 904 may indicate to other UEs, such as the second UE 906, the time-frequency resources allocated for the first UE 904 using control information (for example, via SCI signaling such as SCI-1). For example, in some cases, the first UE 904 may not indicate a resource, such as a TO, as reserved in SCI (e.g., in a PSCCH) if the resource is determined as unused for a current CG period or a future CG period. In other cases, the first UE 904 may indicate the resource as unused in SCI if the resource was indicated as “reserved” or allocated, for example, for transmission or retransmission of a TB in a previous SCI for a current CG period or a future period.

At 920, the first UE 904 sends the data prepared at 912 to the second UE 906 as part of a multi-TB communication. The multi-TB communication may be transmitted on a set of TOs, of the CG configuration, that omits one or more unused TOs indicated at 916 or 918.

Note that the process flow 900 illustrated in FIG. 9 is an example of how an indication of unused TOs may be communicated, and aspects of the present disclosure may be applied to handling of the indication of unused TOs in various manners. Note that the process flow 900 illustrated in FIG. 9 is described herein to facilitate an understanding of how an indication of unused TOs may be communicated, and aspects of the present disclosure may be performed in various manners via alternative or additional signaling and/or operations. In certain aspects, the operations and/or signaling of FIG. 9 may occur in an order different from that described or depicted, and various actions, operations, and/or signaling may be added, omitted, or combined.

Referring now to FIGS. 10-13, example configurations of unused TOs determined at 914 of FIG. 9 are described.

FIG. 10 depicts an example 1000 of configuration of unused TOs for sidelink communications for a CG period. In example 1000 depicted in FIG. 10, a first set of TOs 1002 are used TOs and a second set of TOs 1004 are unused TOs for a given CG period, where a number of consecutive TOs at the end of the CG period (the second set of TOs 1004) are identified as unused TOs. In certain aspects, a CG configuration, such as the CG configuration obtained by the first UE 904 at 908 of FIG. 9, configures a given number of TOs in each CG period for PSSCH transmission. In some aspects, the TOs configured for PSSCH transmission may be referred to as PSSCH resources. It is up to a sidelink communications TX UE, such as the first UE 904 of FIG. 9, to determine initial transmission and retransmission resources for each TB within the CG period. For example, a network entity, such as the network entity 902 of FIG. 9, may configure 9 TOs within a CG period, for a maximum of 3 TBs for the CG period, where the maximum number of TBs for a given CG period may be configured by the network entity. Each TB of the maximum of 3 TBs may be allocated 3 TOs via configuration by the network entity, where the number of TOs configured for each TB may be specified (e.g., in a wireless communications specification) or pre-determined by the network entity (e.g., via configuration or system information). In certain aspects, the configured number of TOs for each TB may be a nominal value, where the actual number of TOs used for transmission may be different than the configured number of TOs. For example, the actual number of TOs used for transmission may be smaller than the configured number of TOs. In some aspects, the actual number of TOs used for a TB may be up to the sidelink communications TX UE, such as the first UE 904 of FIG. 9.

Upon receipt of a data packet in the CG period, the sidelink communications TX UE may determine a number of TBs to transmit the data packet, such as 1, 2, or 3 TBs in the above example. If the number of TBs identified by the sidelink communications TX UE is smaller than the configured number of TBs (3 in this example), the sidelink communications TX UE may identify one or more TOs towards the end of the CG period as unused, such that the TOs that are earliest in time during the CG period are used for transmitting the data packet, thereby reducing the associated latency when compared to using later TOs to transmit the data packet. For example, the sidelink communications TX UE may first identify a final TO of the CG period (e.g., a TO with a highest index or a latest time occurrence) as unused, then may continue to identify TOs of the CG period, moving backward in time from the final TO, as unused.

In some cases, the sidelink communications TX UE may transmit the TBs one-by-one. That is, the sidelink communications TX UE may transmit the first TB first, followed by retransmission of the first TB if needed. Then, the sidelink communications TX UE may transmit the second TB, followed by retransmission of the second TB if needed, etc. In this example, the identification of unused TOs at the end of a given CG period is based on the number of TBs to be transmitted in the CG period. For example, in the example described above, if 2 TBs are to be transmitted in the CG period (with 3 TOs used per TB), the last 3 TOs may be identified as unused (as depicted in FIG. 10), and if 1 TB is to be transmitted in the CG period, the last 6 TOs may be identified as unused, etc.

In other cases, the sidelink communications TX UE may first transmit initial transmissions of the TBs one-by-one, followed by retransmissions of the TBs if needed. That is, the sidelink communications TX UE may transmit an initial transmission for each TB first for all TBs to be transmitted in a given CG period. Then, the sidelink communications TX UE may subsequently transmit retransmission for each TB if needed. For example, in the example described above, for transmitting 3 TBs in a CG period, an initial transmission of the first TB may be transmitted first, followed by an initial transmission of the second TB and an initial transmission of the third TB, then followed by a first retransmission of the first TB if needed, a first retransmission of the second TB if needed, a first retransmission of the third TB if needed, a second retransmission of the first TB if needed, etc. A retransmission of a TB may be needed if an initial transmission of the TB fails, or if a configuration of the TB indicates to perform retransmission of the TB.

In some aspects, the identification of unused TOs at the end of a given CG period is based on the number of TBs to be transmitted in the CG period. For example, in the example described above, if 2 TBs are to be transmitted in the CG period, the last 3 TOs may be identified as unused (as depicted in FIG. 10), and if 1 TB is to be transmitted in the CG period, the last 6 TOs may be identified as unused.

In some aspects, the identification of number of TOs at the end of the CG period is further based on the number of retransmissions needed for the first TB. For example, if 2 TBs are to be transmitted in the CG period, where 2 transmissions, such as an initial transmission and a retransmission, are expected for the first TB and 2transmissions are expected for the second TB, then the sidelink communications TX UE may identify the last 5 TOs as unused. In some cases, all 5 unused TOs may be indicated as unused (e.g., cancelled or recycled), and in other cases, only a subset (e.g., a proper subset, less than all) of the 5 unused TOs may be indicated as unused (e.g., cancelled or recycled). By indicating the subset of the 5 unused TOs as unused, the sidelink communications TX UE may keep one or more TOs for other purposes. In some aspects, the indication of a TO as unused may be referred to as a cancellation of the TO.

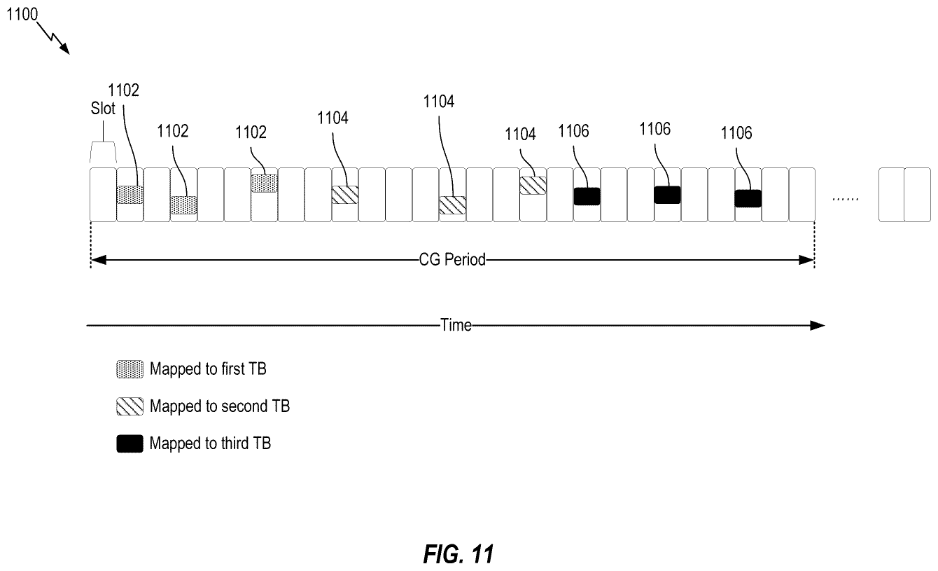

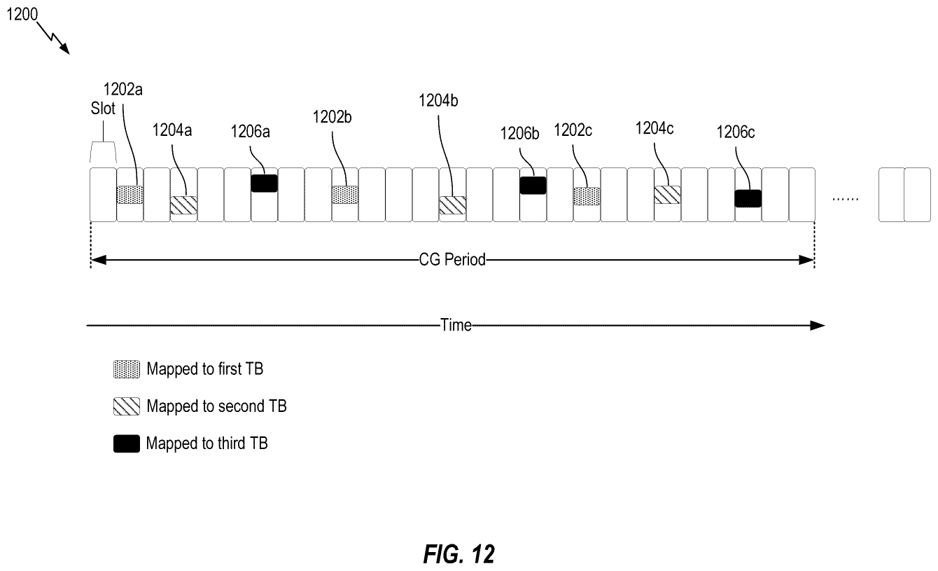

FIGS. 11 and 12 depict additional examples 1100 and 1200 of configurations of unused TOs for sidelink communications for a CG period. Particularly, examples 1100 and 1200 depict identifying unused TOs based on a TO-to-TB mapping. In certain aspects, a CG configuration, such as the CG configuration obtained by the first UE 904 at 908 of FIG. 9, configures a given number of TOs in each CG period for PSSCH transmission based on a TO-to-TB mapping, where the TO-to-TB mapping may be indicated or implied in the CG configuration. A TO-to-TB mapping includes information that indicates how a particular TO may be configured to transmit a given TB. As just one example, a TO-to-TB mapping may indicate a one-to-one, many-to-one, one-to-many, or many-to-many relationship between a TO and a TB, indicating that the TB is to be transmitted on the TO.

In certain aspects, the TO-to-TB mapping corresponding to at least one of the examples 1100 or 1200 may be specified (e.g., in a wireless communications specification), and the network entity may configure the TOs within each CG period and a number of TOs per TB. Then, the first UE 904 may determine the number of TBs within a CG period (e.g., as implied based on the number of TOs per TB), and assign each TB to correct TOs according to example 1100 or example 1200. In certain aspects, the TO-to-TB mapping corresponding to at least one of the examples 1100 and 1200 may be specified (e.g., in a wireless communications specification), and the network entity may configure the TOs within each CG period and a number of TBs within a CG period. Then, the first UE 904 may determine the number of TOs for each TB (e.g., as implied based on the number of TBs within the CG period), and assign each TB to correct TOs according to example 1100 or example 1200. In certain aspects, the TO-to-TB mapping corresponding to both of the examples 1100 and 1200 may be specified (e.g., in a wireless communications specification), and the network entity may configure (1) the TOs within each CG period and a number of TOs per TB, or (2) the TOs within each CG period and a number of TBs within a CG period. In the first case, the first UE 904 may determine the number of TBs within a CG period, and assign each TB to correct TOs. In the second case, the first UE 904 may determine the number of TOs for each TB, and assign each TB to correct TOs.

For example, in the example described above where the network entity configures 9 TOs within a CG period for transmitting 3 TBs, with each TB configured to use 3 TOs, there are multiple ways to map TOs to each TB. In some cases, consecutive TOs may be mapped to a TB, such as a first TB, as depicted in FIG. 11, where consecutive TOs for other TBs, such as second and third TBs may follow after the TOs mapped to the first TB. For example, first TOs 1102, second TOs 1104, and third TOs 1106 may be mapped to, respectively, the first TB, the second TB, and the third TB. In other cases, TOs for different TBs may be interleaved in time, as depicted in FIG. 12. For example, first TOs 1202a/b/c, second TOs 1204a/b/c, and third TOs 1206a/b/c may be mapped to, respectively, the first TB, the second TB, and the third TB. A TO mapped to a TB may be configured or selected for transmission of the TB.

In these cases, the identification of unused TOs may be on a per-TB basis. That is, a sidelink communications TX UE, such as the first UE 904 of FIG. 9, may identify a number of TBs to be transmitted in a given CG period. In some cases, later TOs may be identified as unused if the number of TBs to be transmitted in the CG period is smaller than a total number of TBs configured in the CG period. For example, when 9 TOs are configured for 3 TBs, and if only 2 TBs are to be transmitted in the CG period, the TOs corresponding to the third TB, such as the third TOs 1106 of FIG. 11 and the third TOs 1206a/b/c of FIG. 12, may be identified as unused. In other cases, the sidelink communications TX UE may identify TOs for any TB as unused. For example, when 9TOs are configured for 3 TBs, and if only 2 TBs are to be transmitted in the CG period, the TOs corresponding to the first, second, or third TB may be identified as unused. That is, the sidelink communications TX UE may specifically call out the TOs corresponding to a particular TB, such as the third TB in FIGS. 11 and 12, as unused.

For these aspects, when sets of consecutive TOs are mapped to respective TBs, the sidelink communications TX UE may use a reduced size of a buffer for transmitting a TB, compared to when the TOs are interleaved in time, since the sidelink communications TX UE only needs to be concerned with a single TB at once. When TOs are interleaved in time, a latency associated with sending a data packet for the CG period may be reduced, when compared to when the TOs are organized as sets of consecutive TOs, particularly when a data packet may be successfully received and decoded by a sidelink communications RX UE without any retransmission.

FIG. 13 depicts another example 1300 of a configuration of unused TOs for sidelink communications for a CG period. Particularly, example 1300 of FIG. 13 depicts a configuration of unused TOs for sidelink communications as reported via an uplink resource. Uplink resources may be configured for reporting unused TOs, such as identified by a sidelink communications TX UE at 914 of FIG. 9. In certain aspects, the report of unused TOs, corresponding to 916 of FIG. 9, may be sent as a UCI. In some aspects, periodical uplink resources, such as PUCCH resources, may be configured for reporting the unused TOs according to a reporting period. For example, the reporting period of the periodical uplink resources may be the same as the CG PSSCH period (illustrated as “CG period”). In each reporting period, one or more resources, such as resource 1306, may be configured (such as by a network entity) for the reporting of the unused TOs. For example, a single resource 1306 may be configured, or multiple resources 1306 may be configured at different times.

In certain aspects, the time location of the configured resource(s) 1306 for the reporting may occur earlier than at least a subset of the TOs (e.g., at least one TO) configured by the CG configuration in the CG period, such that as many unused TOs as possible may be reported as unused and be recycled for other communications for improved resource utilization/efficiency. For example, in the example described above, if only 1 TB is to be transmitted, for example, via first TOs 1302 in the CG period and the resource 1306 is used to report unused TOs 1304, the unused TOs 1304 may be re-allocated, for example, by a network entity, to be used for other communications.

In various aspects, a sidelink communications TX UE may report information related to the unused TOs and/or TBs as (1) an integer value to indicate the number of TOs to be unused, (2) a bitmap to indicate the number of TOs to be unused, (3) an integer value to indicate the number of TBs to be unused, or (4) a bitmap to indicate locations of TBs to be unused. In the example described above, where 9 TOs are configured for transmitting 3 TBs in a CG period, the integer value to indicate the number of TOs to be unused may be a value between 0 and 9, reported to indicate the number of TOs to be unused in the CG period. The bitmap to indicate the number of TOs to be unused may be a bitmap of 9 bits (or less, depending on the number of TOs indicated in the report), used to report the TO(s) to be unused in the CG period. Furthermore, the integer value to indicate the number of TBs to be unused may be a value between 0 and 3, reported to indicate the number of TBs to be unused in the CG period. In some aspects, the number of TBs to be unused may be referred to as a quantity of untransmitted blocks. Moreover, the bitmap to indicate locations of TBs to be unused may be a bitmap of 3 bits that indicate the TB(s) to be unused in the CG period).

### Example Operations of a User Equipment

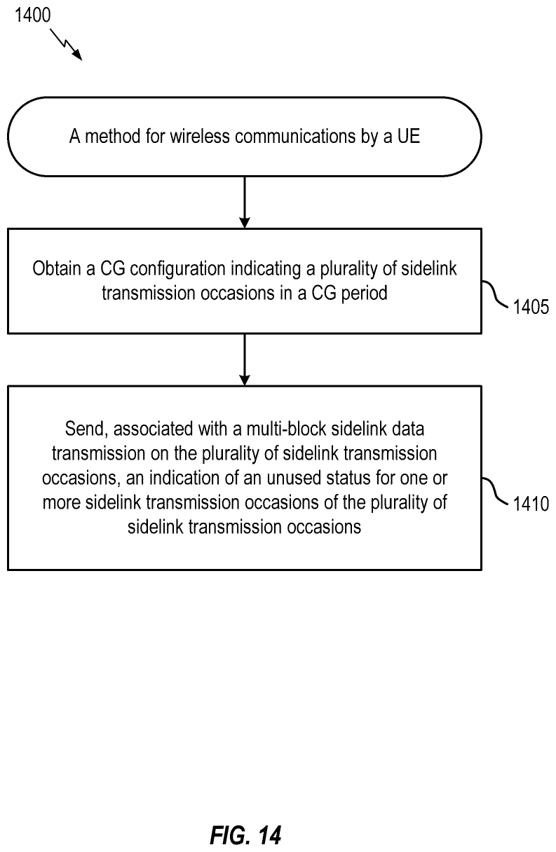

FIG. 14 shows a method 1400 for wireless communications by an apparatus, such as UE 104 of FIG. 1 or UE 304 of FIG. 3.

Method 1400 begins at block 1405 with obtaining a CG configuration indicating a plurality of sidelink transmission occasions in a CG period, as performed at 908 of FIG. 9. The CG configuration is depicted and described with respect to FIGS. 7, 8A, and 8B.

Method 1400 then proceeds to block 1410 with sending, associated with a multi-block sidelink data transmission on the plurality of sidelink transmission occasions, an indication of an unused status for one or more sidelink transmission occasions of the plurality of sidelink transmission occasions, as performed at 916, 918 of FIG. 9. Additional details regarding the indication of the unused status of the one or more sidelink transmission occasions are depicted and described with respect to FIGS. 10-13.

In some aspects, the indication of the unused status is based at least in part on a packet size associated with the multi-block sidelink data transmission.

In some aspects, the indication of the unused status is based at least in part on at least one of: a number of blocks of the multi-block sidelink data transmission, or a number of retransmissions associated with the multi-block sidelink data transmission.

In some aspects, method 1400 further includes receiving a configuration of a resource, wherein block 1410 includes sending the indication on the resource.

In some aspects, the resource is an uplink resource, and block 1410 includes sending the indication to a network entity, as performed at 916 of FIG. 9.

In some aspects, the resource is a periodic resource that occurs earlier in the CG period than at least one sidelink transmission occasion of the plurality of sidelink transmission occasions.

In some aspects, the indication further indicates one or more PSSCH resources associated with the CG configuration.

In some aspects, the one or more PSSCH resources are used for the multi-block sidelink data transmission. In certain aspects, “used for” may mean “reserved for,” “allocated for,” and/or “for transmission on these resources.”

In some aspects, the one or more PSSCH resources are reserved for the UE, and the indication indicates the one or more PSSCH resources as having the unused status.

In some aspects, the one or more sidelink transmission occasions are a latest one or more sidelink transmission occasions of the CG period.

In some aspects, the multi-block sidelink data transmission includes a set of blocks, wherein the unused status for the one or more sidelink transmission occasions is based at least in part on the set of blocks and a quantity of retransmissions of the set of blocks.

In some aspects, method 1400 further includes sending the multi-block sidelink data transmission with the set of blocks on an earliest set of sidelink transmission occasions of the CG period.

In some aspects, sending the multi-block sidelink data transmission comprises sending one or more initial transmissions of the set of blocks prior to the quantity of retransmissions of the set of blocks.

In some aspects, the CG configuration indicates a mapping between the plurality of sidelink transmission occasions and a set of blocks of the multi-block sidelink data transmission.

In some aspects, the multi-block sidelink data transmission includes a first block and a second block, wherein the first block is associated with an earliest set of sidelink transmission occasions of the plurality of sidelink transmission occasions, and wherein the second block is associated with a later set of sidelink transmission occasions, of the plurality of sidelink transmission occasions, that occur later than the earliest set of sidelink transmission occasions.

In some aspects, the multi-block sidelink data transmission includes a first block associated with a first set of sidelink transmission occasions of the plurality of sidelink transmission occasions and a second block associated with a second set of sidelink transmission occasions of the plurality of sidelink transmission occasions, wherein the first set of sidelink transmission occasions are interleaved with the second set of sidelink transmission occasions in time.

In some aspects, the indication indicates a quantity of the one or more sidelink transmission occasions having the unused status.

In some aspects, the indication comprises a bitmap that indicates the one or more sidelink transmission occasions having the unused status.

In some aspects, the indication indicates a quantity of untransmitted blocks of the multi-block sidelink data transmission, wherein the one or more sidelink transmission occasions are based at least in part on the quantity of untransmitted blocks.

In some aspects, the indication comprises a bitmap that indicates one or more untransmitted blocks of the multi-block sidelink data transmission, wherein the one or more sidelink transmission occasions are based at least in part on the one or more untransmitted blocks.

In some aspects, block 1410 includes sending the indication via SCI.

In some aspects, the SCI indicates a cancellation of the one or more sidelink transmission occasions, wherein the one or more sidelink transmission occasions are associated with a previous reservation.

In some aspects, the SCI indicates a set of reserved sidelink transmission occasions of the plurality of sidelink transmission occasions, wherein the indication of the unused status is based at least in part on the set of reserved sidelink transmission occasions.

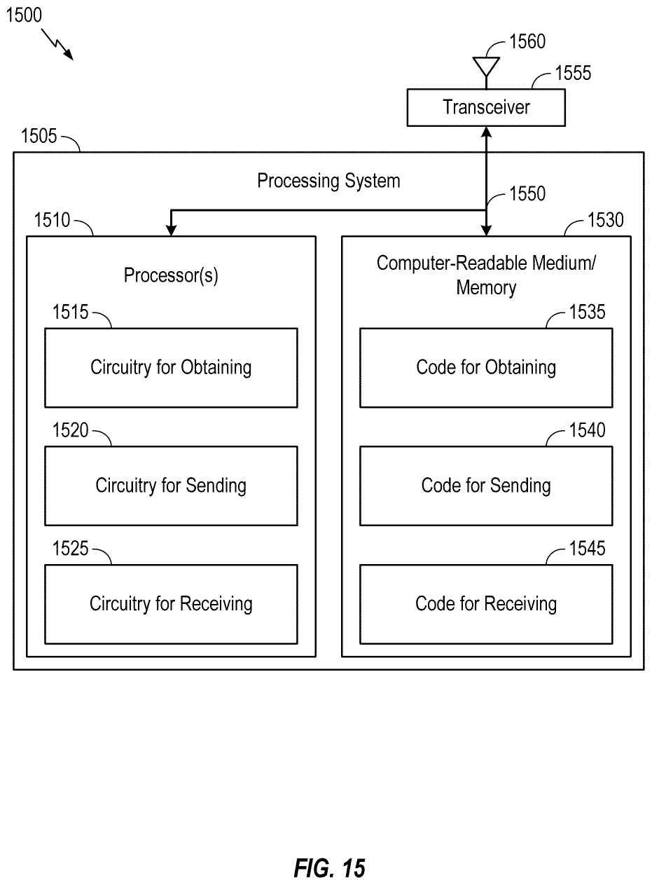

In some aspect, method 1400, or any aspect related to it, may be performed by an apparatus, such as communications device 1500 of FIG. 15, which includes various components operable, configured, or adapted to perform the method 1400. Communications device 1500 is described below in further detail. In certain aspects, the method 1400 provides various technical benefits. For example, sending an indication of an unused status for one or more sidelink transmission occasions at block 1410 may generally aid a network entity and/or a sidelink communications RX UE in re-allocating time and frequency resources associated with the one or more sidelink transmission occasions with the unused status, thus increasing throughput and spectral efficiency.

Additionally, when the multi-block sidelink data transmission includes a first block, associated with an earlier (e.g., consecutive) set of transmission occasions, and a second block, associated with a later (e.g., consecutive) set of transmission occasions and the later set of transmission occasions are indicated with an unused status, a sidelink communications TX UE may use a reduced size of a buffer for transmitting a TB, when compared to when the transmission occasions are interleaved in time, since the UE only needs to be concerned with a single TB at once. When transmission occasions are interleaved in time, a latency associated with sending a data packet for a CG period may be reduced, when compared to when the transmission occasions are organized as sets of consecutive transmission occasions, particularly when a data packet may be successfully received and decoded by a sidelink communications RX UE without any retransmission.

Note that FIG. 14 is just one example of a method, and other methods including fewer, additional, or alternative operations are possible consistent with this disclosure.

### Example Communications Devices

FIG. 15 depicts aspects of an example communications device 1500 configured for wireless communications. In some aspects, communications device 1500 is a user equipment, such as UE 104 described above with respect to FIG. 1 or UE 304 described with respect to FIG. 3.

The communications device 1500 includes a processing system 1505 coupled to a transceiver 1555 (e.g., a transmitter and/or a receiver). The transceiver 1555 is configured to transmit and receive signals for the communications device 1500 via an antenna 1560, such as the various signals as described herein. The processing system 1505 may be configured to perform processing functions for the communications device 1500, including processing signals received and/or to be transmitted by the communications device 1500.

The processing system 1505 includes one or more processors 1510 and a computer-readable medium/memory 1530. In various aspects, the one or more processors 1510 may be representative of the one or more processors 318 described with respect to FIG. 3. The one or more processors 1510 are coupled to a computer-readable medium/memory 1530 via a bus 1550. In some aspects, the computer-readable medium/memory 1530 may be representative of the one or more memories 320 described with respect to FIG. 3. The computer-readable medium/memory 1530 is a non-transitory computer-readable medium/memory. In certain aspects, the computer-readable medium/memory 1530 is configured to store instructions (e.g., computer-executable code), that when executed by the one or more processors 1510, cause the one or more processors 1510 to perform the method 1400 described with respect to FIG. 14, or any aspect related to it, including any operations described in relation to FIG. 14. Note that reference to a processor performing a function of communications device 1500 may include one or more processors performing that function of communications device 1500, such as in a distributed fashion.

In the depicted example, computer-readable medium/memory 1530 stores code (e.g., executable instructions), including code for obtaining 1535, code for sending 1540, and code for receiving 1545. Processing of the code 1535-1545 may enable and cause the communications device 1500 to perform the method 1400 described with respect to FIG. 14, or any aspect related to it.

The one or more processors 1510 include circuitry configured to implement (e.g., execute) the code stored in the computer-readable medium/memory 1530, including circuitry for obtaining 1515, circuitry for sending 1520, and circuitry for receiving 1525. Processing with circuitry 1515-1525 may enable and cause the communications device 1500 to perform the method 1400 described with respect to FIG. 14, or any aspect related to it.

More generally, means for communicating, transmitting, sending or outputting for transmission may include the one or more transceivers 324, one or more antenna 322 and/or processing system 316 of the UE 304 illustrated in FIG. 3, transceiver 1555 and/or antenna 1560 of the communications device 1500 in FIG. 15, and/or one or more processors 1510 of the communications device 1500 in FIG. 15. Means for communicating, receiving or obtaining may include the one or more transceivers 324, one or more antennas 322, and/or processing system 316 of the UE 304 illustrated in FIG. 3, transceiver 1555 and/or antenna 1560 of the communications device 1500 in FIG. 15, and/or one or more processors 1510 of the communications device 1500 in FIG. 15.

### EXAMPLE CLAUSES

Implementation examples are described in the following numbered clauses:

Clause 1: A method for wireless communications by a UE comprising: obtaining a CG configuration indicating a plurality of sidelink transmission occasions in a CG period; and sending, associated with a multi-block sidelink data transmission on the plurality of sidelink transmission occasions, an indication of an unused status for one or more sidelink transmission occasions of the plurality of sidelink transmission occasions.

Clause 2: The method of Clause 1, wherein the indication of the unused status is based at least in part on a packet size associated with the multi-block sidelink data transmission.

Clause 3: The method of Clause 2, wherein the indication of the unused status is based at least in part on at least one of: a number of blocks of the multi-block sidelink data transmission, or a number of retransmissions associated with the multi-block sidelink data transmission.

Clause 4: The method of any one of Clauses 1-3, further comprising receiving a configuration of a resource, wherein sending the indication comprises sending the indication on the resource.

Clause 5: The method of Clause 4, wherein the resource is an uplink resource, and sending the indication comprises sending the indication to a network entity.

Clause 6: The method of Clause 4, wherein the resource is a periodic resource that occurs earlier in the CG period than at least one sidelink transmission occasion of the plurality of sidelink transmission occasions.

Clause 7: The method of any one of Clauses 1-6, wherein the indication further indicates one or more PSSCH resources associated with the CG configuration.

Clause 8: The method of Clause 7, wherein the one or more PSSCH resources are used for the multi-block sidelink data transmission.

Clause 9: The method of Clause 7, wherein the one or more PSSCH resources are reserved for the UE, and wherein the indication indicates the one or more PSSCH resources as having the unused status.

Clause 10: The method of any one of Clauses 1-9, wherein the one or more sidelink transmission occasions are a latest one or more sidelink transmission occasions of the CG period.

Clause 11: The method of any one of Clauses 1-10, wherein the multi-block sidelink data transmission includes a set of blocks, wherein the unused status for the one or more sidelink transmission occasions is based at least in part on the set of blocks and a quantity of retransmissions of the set of blocks.

Clause 12: The method of Clause 11, further comprising sending the multi-block sidelink data transmission with the set of blocks on an earliest set of sidelink transmission occasions of the CG period.

Clause 13: The method of Clause 12, wherein sending the multi-block sidelink data transmission comprises sending one or more initial transmissions of the set of blocks prior to the quantity of retransmissions of the set of blocks.

Clause 14: The method of any one of Clauses 1-13, wherein the CG configuration indicates a mapping between the plurality of sidelink transmission occasions and a set of blocks of the multi-block sidelink data transmission.

Clause 15: The method of any one of Clauses 1-14, wherein the multi-block sidelink data transmission includes a first block and a second block, wherein the first block is associated with an earliest set of sidelink transmission occasions of the plurality of sidelink transmission occasions, and wherein the second block is associated with a later set of sidelink transmission occasions, of the plurality of sidelink transmission occasions, that occur later than the earliest set of sidelink transmission occasions.

Clause 16: The method of any one of Clauses 1-15, wherein the multi-block sidelink data transmission includes a first block associated with a first set of sidelink transmission occasions of the plurality of sidelink transmission occasions and a second block associated with a second set of sidelink transmission occasions of the plurality of sidelink transmission occasions, wherein the first set of sidelink transmission occasions are interleaved with the second set of sidelink transmission occasions in time.

Clause 17: The method of any one of Clauses 1-16, wherein the indication indicates a quantity of the one or more sidelink transmission occasions having the unused status.

Clause 18: The method of any one of Clauses 1-17, wherein the indication comprises a bitmap that indicates the one or more sidelink transmission occasions having the unused status.

Clause 19: The method of any one of Clauses 1-18, wherein the indication indicates a quantity of untransmitted blocks of the multi-block sidelink data transmission, wherein the one or more sidelink transmission occasions are based at least in part on the quantity of untransmitted blocks.

Clause 20: The method of any one of Clauses 1-19, wherein the indication comprises a bitmap that indicates one or more untransmitted blocks of the multi-block sidelink data transmission, wherein the one or more sidelink transmission occasions are based at least in part on the one or more untransmitted blocks.

Clause 21: The method of any one of Clauses 1-20, wherein sending the indication comprises sending the indication via SCI.

Clause 22: The method of Clause 21, wherein the SCI indicates a cancellation of the one or more sidelink transmission occasions, wherein the one or more sidelink transmission occasions are associated with a previous reservation.

Clause 23: The method of Clause 21, wherein the SCI indicates a set of reserved sidelink transmission occasions of the plurality of sidelink transmission occasions, wherein the indication of the unused status is based at least in part on the set of reserved sidelink transmission occasions.

Clause 24: One or more apparatuses, comprising: one or more memories comprising executable instructions; and one or more processors configured to execute the executable instructions and cause the one or more apparatuses to perform a method in accordance with any one of Clauses 1-23.

Clause 25: One or more apparatuses configured for wireless communications, comprising: one or more memories; and one or more processors, coupled to the one or more memories, configured to cause the one or more apparatuses to perform a method in accordance with any one of Clauses 1-23.

Clause 26: One or more apparatuses configured for wireless communications, comprising: one or more memories; and one or more processors, coupled to the one or more memories, configured to perform a method in accordance with any one of Clauses 1-23.

Clause 27: One or more apparatuses, comprising means for performing a method in accordance with any one of Clauses 1-23.

Clause 28: One or more non-transitory computer-readable media comprising executable instructions that, when executed by one or more processors of one or more apparatuses, cause the one or more apparatuses to perform a method in accordance with any one of Clauses 1-23.

Clause 29: One or more computer program products embodied on one or more computer-readable storage media comprising code for performing a method in accordance with any one of Clauses 1-23.

Clause 30: A user equipment (UE), comprising: a processing system that includes processor circuitry and memory circuitry that stores code and is coupled with the processor circuitry, the processing system configured to cause the UE to perform a method in accordance with any one of Clauses 1-23.

Clause 31: One or more apparatuses configured for wireless communications, comprising: a processing system that includes one or more processors and one or more memories coupled with the one or more processors, the processing system configured to cause the one or more apparatuses to perform a method in accordance with any one of Clauses 1-23.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
obtain a configured grant (CG) configuration indicating a plurality of sidelink transmission occasions in a CG period; and
send, associated with a multi-block sidelink data transmission on the plurality of sidelink transmission occasions, an indication of an unused status for one or more sidelink transmission occasions of the plurality of sidelink transmission occasions.

2. The apparatus of claim 1, wherein the indication of the unused status is based at least in part on a packet size associated with the multi-block sidelink data transmission.

3. The apparatus of claim 2, wherein the indication of the unused status is based at least in part on at least one of:
a number of blocks of the multi-block sidelink data transmission, or
a number of retransmissions associated with the multi-block sidelink data transmission.

4. The apparatus of claim 1, wherein the processing system is configured to further cause the UE to receive a configuration of a resource, wherein the processing system, to cause the UE to send the indication, is configured to cause the UE to send the indication on the resource.

5. The apparatus of claim 4, wherein the resource is an uplink resource, and wherein the processing system, to cause the UE to send the indication, is configured to cause the UE to send the indication to a network entity.

6. The apparatus of claim 4, wherein the resource is a periodic resource that occurs earlier in the CG period than at least one sidelink transmission occasion of the plurality of sidelink transmission occasions.

7. The apparatus of claim 1, wherein the indication further indicates one or more physical sidelink shared channel (PSSCH) resources associated with the CG configuration.

8. The apparatus of claim 7, wherein the one or more PSSCH resources are used for the multi-block sidelink data transmission.

9. The apparatus of claim 7, wherein the one or more PSSCH resources are reserved for the UE, and wherein the indication indicates the one or more PSSCH resources as having the unused status.

10. The apparatus of claim 1, wherein the one or more sidelink transmission occasions are a latest one or more sidelink transmission occasions of the CG period.

11. The apparatus of claim 1, wherein the multi-block sidelink data transmission includes a set of blocks, wherein the unused status for the one or more sidelink transmission occasions is based at least in part on the set of blocks and a quantity of retransmissions of the set of blocks.

12. The apparatus of claim 11, wherein the processing system is configured to cause the UE to send the multi-block sidelink data transmission with the set of blocks on an earliest set of sidelink transmission occasions of the CG period.

13. The apparatus of claim 12, wherein to cause the UE to send the multi-block sidelink data transmission, the processing system is configured to cause the UE to send one or more initial transmissions of the set of blocks prior to the quantity of retransmissions of the set of blocks.

14. The apparatus of claim 1, wherein the CG configuration indicates a mapping between the plurality of sidelink transmission occasions and a set of blocks of the multi-block sidelink data transmission.

15. The apparatus of claim 1, wherein the multi-block sidelink data transmission includes a first block and a second block, wherein the first block is associated with an earliest set of sidelink transmission occasions of the plurality of sidelink transmission occasions, and wherein the second block is associated with a later set of sidelink transmission occasions, of the plurality of sidelink transmission occasions, that occur later than the earliest set of sidelink transmission occasions.

16. The apparatus of claim 1, wherein the multi-block sidelink data transmission includes a first block associated with a first set of sidelink transmission occasions of the plurality of sidelink transmission occasions and a second block associated with a second set of sidelink transmission occasions of the plurality of sidelink transmission occasions, wherein the first set of sidelink transmission occasions are interleaved with the second set of sidelink transmission occasions in time.

17. The apparatus of claim 1, wherein the indication indicates a quantity of the one or more sidelink transmission occasions having the unused status.

18. The apparatus of claim 1, wherein the indication comprises a bitmap that indicates the one or more sidelink transmission occasions having the unused status.

19. A method for wireless communications by a user equipment (UE), comprising:
obtaining a configured grant (CG) configuration indicating a plurality of sidelink transmission occasions in a CG period; and
sending, associated with a multi-block sidelink data transmission on the plurality of sidelink transmission occasions, an indication of an unused status for one or more sidelink transmission occasions of the plurality of sidelink transmission occasions.

20. An apparatus for wireless communications, the apparatus comprising:
means for obtaining a configured grant (CG) configuration indicating a plurality of sidelink transmission occasions in a CG period; and
means for sending, associated with a multi-block sidelink data transmission on the plurality of sidelink transmission occasions, an indication of an unused status for one or more sidelink transmission occasions of the plurality of sidelink transmission occasions.
